(19) United States
(12) Patent Application Publication
(10) Pub. No.: US 2024/0371572 A1
(43) Pub. Date: Nov. 7, 2024

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 18/773,739

(22) Filed: Jul. 16, 2024

Related U.S. Application Data
(63) Continuation of application No. PCT/JP2023/015061, filed on Apr. 13, 2023.

(30) Foreign Application Priority Data
Jun. 2, 2022 (JP) 2022-090246

(51) Int. Cl. H01G 4/30; H01G 4/01; H01G 4/12

(52) U.S. Cl. CPC H01G 4/30; H01G 4/01; H01G 4/1209

(57) ABSTRACT

A multilayer ceramic capacitor includes external electrodes including metal layers on first and second end surfaces and covering internal electrodes extending to the first and second end surfaces, respectively, glass films on the first and second end surfaces, adjacent to the metal layers and extending around the metal layers, fired layers including glass and metal, and covering the metal layers, and plating films covering the fired layers. A thickness of the metal layer is between about 0.1 μm and about 15.0 μm inclusive, and a thickness of the fired layer is between about 0.1 μm and about 1.0 μm inclusive.

### CROSS REFERENCE TO RELATED APPLICATIONS

This application claims the benefit of priority to Japanese Patent Application No. 2022-090246 filed on Jun. 2, 2022 and is a Continuation of PCT Application No. PCT/JP2023/015061 filed on Apr. 13, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

Known multilayer ceramic capacitors include a multilayer body in which dielectric layers and internal electrodes are alternately stacked, and external electrodes electrically connected to the internal electrodes and provided on the surface of the multilayer body. Japanese Unexamined Patent Application, Publication No. 2007-266208 discloses a method of forming external electrodes on a multilayer ceramic capacitor.

A problem with the multilayer ceramic capacitors including external electrodes is insufficient moisture resistance reliability. One of the factors of insufficient moisture resistance reliability is the occurrence of cracks in the external electrodes.

### SUMMARY OF THE INVENTION

Example embodiments of the present invention provide multilayer ceramic capacitors each with improved moisture resistance reliability, and able to reduce or prevent an occurrence of cracks in the external electrodes.

A multilayer ceramic capacitor according to an example embodiment of the present invention includes a multilayer body including a plurality of dielectric layers and a plurality of internal electrodes alternately stacked, and a pair of external electrodes on surfaces of the multilayer body and electrically connected to the internal electrodes extending to the surfaces of the multilayer body, respectively. The multilayer body includes first and second main surfaces on opposite sides in a thickness direction that is a lamination direction of the dielectric layers and the internal electrodes, first and second end surfaces on opposite sides in a length direction in which the external electrodes face each other, the external electrodes being provided on the first and second end surfaces, and first and second lateral surfaces on opposite sides in a width direction orthogonal or substantially orthogonal to both of the thickness direction and the length direction. The external electrodes include a metal layer on the first and second end surfaces, so as to cover the internal electrodes extending to the first and second end surfaces, respectively, a glass film on the first and second end surfaces, the glass film being adjacent to the metal layer and provided around the metal layer, a fired layer including glass and metal, and covering the metal layer, and a plating film covering the fired layer. The thickness of the metal layer is between about 0.1 μm and about 15.0 μm inclusive, and the thickness of the fired layer is between about 0.1 μm and about 1.0 μm inclusive.

Example embodiments of the present invention provide multilayer ceramic capacitors each achieving improved moisture resistance reliability and reducing or preventing cracks in the external electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of the multilayer ceramic capacitor according to an example embodiment of the present invention.

FIG. 2 is a cross-sectional view taken along the line I-I in FIG. 1.

FIG. 3 is a cross-sectional view taken along the line III-III in FIG. 1.

FIG. 4 is a cross-sectional view taken along the line IV-IV in FIG. 1.

### DETAILED DESCRIPTION OF THE EXAMPLE EMBODIMENTS

The following describes examples of example embodiments of the present invention with reference to the accompanying drawings. The same or equivalent portions in each drawing are designated with the same reference numerals.

### External Shape of Multilayer Ceramic Capacitor

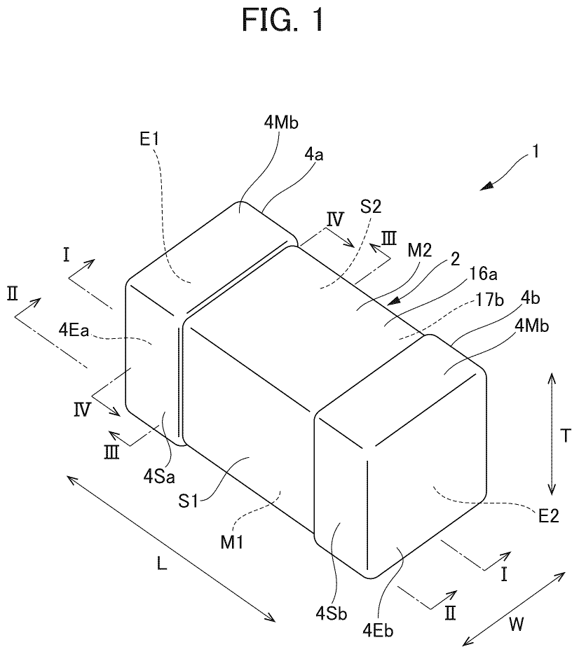

Based on FIG. 1, the general appearance of the multilayer ceramic capacitor 1 will be described. FIG. 1 is a perspective view illustrating the multilayer ceramic capacitor 1 according to the present example embodiment. The multilayer ceramic capacitor 1 includes a multilayer body 2 and external electrodes 4 (4a, 4b) as illustrated in FIG. 1. The external electrodes 4 include a first external electrode 4a and a second external electrode 4b.

### Definition of Directions

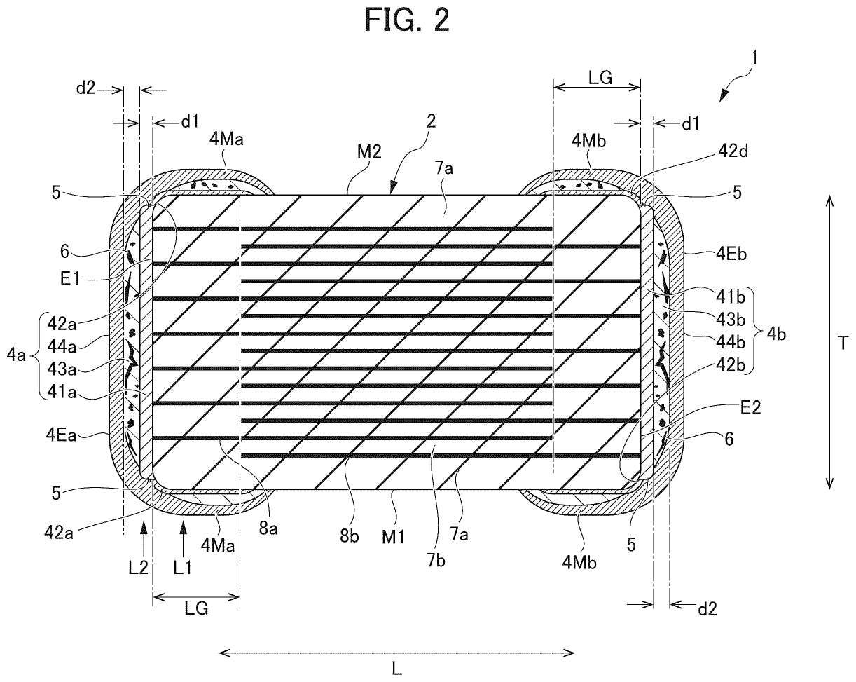

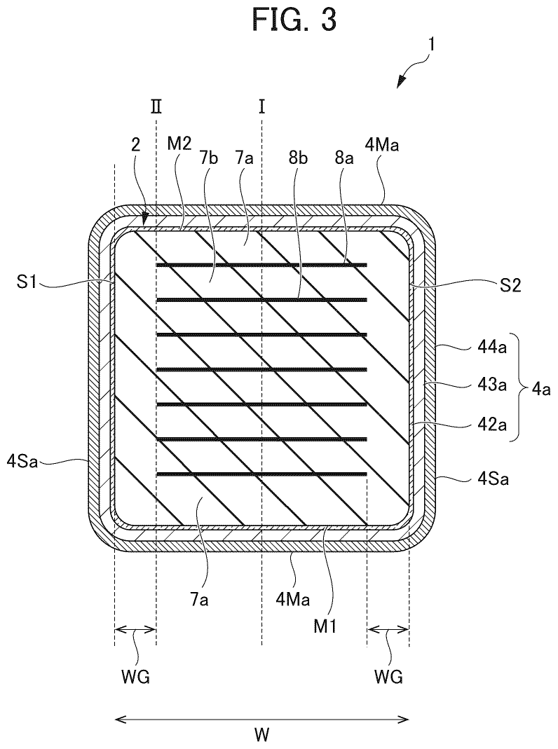

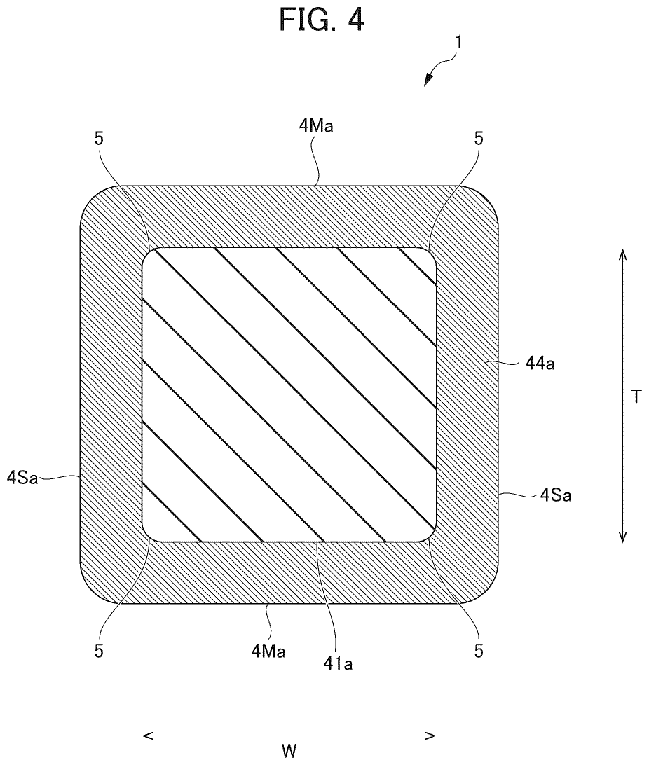

FIGS. 1 to 4 illustrate a L direction, W direction, and T direction. The L direction is a length direction L of the multilayer ceramic capacitor 1. The W direction is a width direction W of the multilayer ceramic capacitor 1. The T direction is the lamination direction, i.e., the thickness direction T of the multilayer ceramic capacitor 1. Thus, the cross-section illustrated in FIG. 2 is referred to as an LT cross-section. The cross-sections illustrated in FIGS. 3 and 4 are referred to as WT cross-sections. The length direction L, width direction w, and thickness direction T do not necessarily have to be orthogonal or substantially orthogonal to each other. The length direction L, width direction W, and thickness direction T may intersect each other.

### External Shape of Multilayer Body

As illustrated in FIG. 1, the shape of the multilayer body 2 is rectangular or substantially rectangular. The multilayer body includes two end surfaces, two main surfaces, and two lateral surfaces. The end surfaces are faces opposing in the length direction L. The main surfaces are surfaces opposing in the thickness direction T. The lateral surfaces are surfaces opposing in the width direction W. The two end surfaces are referred to as a first end surface E1 and a second end surface E2. The two main surfaces are referred to as a first main surface M1 and a second main surface M2. The two lateral surfaces are referred to as a first lateral surface S1 and a second lateral surface S2.

The corner portions and edge portions of the multilayer body 2 are preferably rounded. The corner portions refer to the portions where three surfaces of the multilayer body 2 intersect. The edge portions refer to the portions where two surfaces of the multilayer body 2 intersect.

### Size of Multilayer Body

The size of the multilayer body 2 can be as follows, for example. The dimension of the multilayer body 2 in the length direction L can be between about 200 μm and about 2000 μm inclusive. The dimension of the multilayer body 2 in the thickness direction can be between about 100 μm and about 1000 μm inclusive. The dimension of the multilayer body 2 in the width direction W can be between about 100 μm and about 1000 μm inclusive. The lengths of various portions of the multilayer body 2 can be measured with a micrometer or an optical microscope.

### Internal Structure of Multilayer Body

Based on FIGS. 2 and 3, the internal structure of the multilayer body 2 will be described. FIG. 2 is a cross-sectional view of the multilayer ceramic capacitor, taken along the line I-I in FIG. 1. FIG. 3 is a cross-sectional view of the multilayer ceramic capacitor, taken along the line III-III in FIG. 1.

As illustrated in FIG. 2, the multilayer body 2 includes a plurality of dielectric layers 7 (7a, 7b) and a plurality of internal electrodes 8 (8a, 8b). The plurality of dielectric layers 7 and the plurality of internal electrodes 8 are stacked alternately in the thickness direction T.

### Dielectric Layers

As illustrated in FIG. 2, the dielectric layer 7 includes outer dielectric layers 7a and inner dielectric layers 7b.

### Outer Dielectric Layers

The outer dielectric layer 7a is among the dielectric layers 7, provided on the sides of the first main surface M1 and the second main surface M2 of the multilayer body 2. That is, the outer dielectric layer 7a is the dielectric layer 7 provided on both outer sides of the multilayer body 2 in the thickness direction T. Specifically, the outer dielectric layer 7a is the dielectric layer 7 provided between the first main surface M1 and the internal electrode 8 closest to the first main surface M1, and between the second main surface M2 and the internal electrode 8 closest to the second main surface M2.

### Inner Dielectric Layers

The inner dielectric layer 7b is the dielectric layer 7 provided between the internal electrodes 8. Specifically, the inner dielectric layer 7b is the dielectric layer 7 provided between the first internal electrode 8a and the second internal electrode 8b, which will be described below.

### Internal Electrodes

As illustrated in FIG. 2, the internal electrodes 8 include a first internal electrode 8a and a second internal electrode 8b. The first internal electrode 8a is an internal electrode connected to the first external electrode 4a. The second internal electrode 8b is an internal electrode connected to the second external electrode 4b. The first internal electrode 8a extends from the first end surface E1 towards the second end surface E2. The second internal electrode 8b extends from the second end surface E2 towards the first end surface E1.

### Counter Portions and Extension Portions

The first internal electrode 8a and the second internal electrode 8b each include counter portions and extension portions. The counter portions are the portions where the first internal electrode 8a and the second internal electrode 8b face each other. The extension portions are the portions extending from the counter portions to the end surfaces E1, E2 of the multilayer body 2. Specifically, the extension portion of the first internal electrode 8a is the portion extending from the counter portion to the first end surface E1 of the multilayer body 2. The extension portion of the second internal electrode 8b is the portion extending from the counter portion to the second end surface E2 of the multilayer body 2. A capacitance is generated at the counter portions, where the counter portion of the first internal electrode 8a and the counter portion of the second internal electrode 8b face each other across the inner dielectric layer 7b. Thus, the multilayer ceramic capacitor 1 defines and functions as a capacitor.

### Length Direction Gap

As illustrated in FIG. 2, the region from the tip of the first internal electrode 8a facing the second end surface E2 to the second end surface E2 is designated as a length direction gap LG. Similarly, the region from the tip of the second internal electrode 8b facing the first end surface E1 to the first end surface E1 is also designated as a length direction gap LG. The length of the length direction gap LG in the length direction L can be, for example, between about 5 μm and about 30 μm inclusive.

### Width Direction Gap

As illustrated in FIG. 3, the region from the end portion of the internal electrode 8 in the width direction W to the first lateral surface S1 is designated as a width direction gap WG. Similarly, the region from the end portion of the internal electrode 8 in the width direction W to the second lateral surface S2 is also designated as a width direction gap WG. The length of the width direction gap WG in the width direction W can be, for example, between about 5 μm and about 30 μm inclusive.

### Number of Dielectric Layers

The number of the dielectric layers 7 stacked in the multilayer body 2 can be, for example, between 10 and 1000 layers inclusive. This number of the dielectric layers 7 is the total number of both the outer dielectric layers 7a and the inner dielectric layers 7b.

### Thickness of Dielectric Layers

The thickness of the outer dielectric layers 7a, among the dielectric layers 7, can be, for example, between about 10 μm and about 100 μm inclusive. The thickness of the inner dielectric layers 7b can be, for example, between about 0.3 μm and about 5.0 μm inclusive.

### Material of Dielectric Layers

The material of the dielectric layers 7 can be dielectric ceramics including, for example, BaTiO₃, CaTiO₃, SrTiO₃, or CaZrO₃. The material of the dielectric layers 7 may also include, for example, the dielectric ceramics with additions of compounds such as Mn, Fe, Cr, Co, or Ni compounds.

### Number of Internal Electrodes

The number of the internal electrodes 8 can be, for example, between 10 and 1000 layers inclusive. The number of the internal electrodes 8 includes the total number of both the first internal electrode 8a and the second internal electrode 8b.

### Thickness of Internal Electrodes

The thickness of the internal electrodes 8 can be, for example, between about 0.3 μm and about 5.0 μm inclusive. When the thickness of the internal electrodes 8 is about 0.5 μm or more, the plating film grows more easily during the formation of the metal layer by plating. The metal layer will be described later.

### Material of Internal Electrodes

The material of the internal electrodes 8 can be, for example, metals such as Ni, Cu, Ag, Pd, and Au, or an alloy of Ni and Cu, an alloy of Ag and Pd, etc. Additionally, the material of the internal electrodes 8 may include dielectric particles of the same compositional system as the ceramics included in the dielectric layer 7.

### External Electrodes

As described based on FIG. 1, the external electrodes include the first external electrode 4a and the second external electrode 4b.

### First External Electrode

As illustrated in FIG. 1, the first external electrode 4a is provided on the first end surface E1 of the multilayer body 2. The first external electrode 4a extends from the first end surface E1 to a portion of the two main surfaces and a portion of the two lateral surfaces. The portion of the first external electrode 4a provided on the first end surface E1 of the multilayer body 2 is referred to as the end surface external electrode 4Ea. The portion of the first external electrode 4a provided on a portion of the first main surface M1 or a portion of the second main surface M2 is referred to as the main surface external electrode 4Ma. The portion of the first external electrode 4a provided on a portion of the first lateral surface S1 or a portion of the second lateral surface S2 is referred to as the lateral surface external electrode 4Sa. As illustrated in FIG. 2, the first external electrode 4a is electrically connected to the first internal electrode 8a.

### Second External Electrode

The second external electrode 4b is an external electrode provided on the second end surface E2 of the multilayer body 2. The second external electrode 4b is the same or similar in configuration to the first external electrode 4a. That is, the second external electrode 4b extends from the second end surface E2 to a portion of the two main surfaces and a portion of the two lateral surfaces. The portion of the second external electrode 4b provided on the second end surface E2 of the multilayer body 2 is referred to as the end surface external electrode 4Eb. The portion of the second external electrode 4b provided on portion of the first main surface M1 or portion of the second main surface M2 is referred to as the main surface external electrode 4Mb. The portion of the second external electrode 4b provided on a portion of the first lateral surface S1 or a portion of the second lateral surface S2 is referred to as the lateral surface external electrode 4Sb. As illustrated in FIG. 2, the second external electrode 4b is electrically connected to the second internal electrode 8b.

### Layer Configuration of External Electrodes

The layer configuration of the external electrodes 4 will be described based on FIG. 2. As illustrated in FIG. 2, the first external electrode 4a includes a metal layer 41a, a glass film 42a, a fired layer 43a, and a plating film 44a. The second external electrode 4b includes a metal layer 41b, a glass film 42b, a fired layer 43b, and a plating film 44b. Taking the first external electrode 4a as an example, the layers of the external electrodes 4 will be described. The layers of the second external electrode 4b are the same or similar in configuration to the layers of the first external electrode 4a. Therefore, the description of the first external electrode 4a also applies to the second external electrode 4b.

### Metal Layer

The end portion of the first internal electrode 8a is exposed at the end surface E1. The metal layer 41a is provided on the first end surface E1 to cover the exposed end portion of the first internal electrode 8a. The metal layer 41a can be made from a material that includes at least one metal of Cu, Ni, Ag, Pd, or Au, for example. The metal layer 41a may also be made from alloys, such as an alloy of Cu and Ni or an alloy of Ag and Pd, for example. A portion of the material of the metal layer 41a may diffuse into the first internal electrode 8a in contact with the metal layer 41a. The mixing of the material of the metal layer 41a and the material of the first internal electrode 8a can improve the bonding strength between the metal layer 41a and the first internal electrode 8a.

The metal layer 41a can be formed by plating, for example.

### Thickness of Metal Layer

In FIG. 2, the thickness of the metal layer 41a is indicated by d1. The thickness d1 of the metal layer 41a can be, for example, between about 0.1 μm and about 15.0 μm inclusive. If the thickness d1 of the metal layer 41a is less than about 0.1 μm, the continuity of the metal layer 41a is likely to decrease. Therefore, the bonding strength between the metal layer 41a and the first internal electrode 8a may be reduced. As a result, the electrical conductivity of the metal layer 41a may potentially be decreased. If the thickness d1 of the metal layer 41a exceeds about 15.0 μm, internal stress within the metal layer 41a is likely to increase. As a result, the metal layer 41a may potentially peel away from the first internal electrode 8a.

### Fired Layer

The fired layer 43a is provided to cover at least a portion of the metal layer 41a. The fired layer 43a includes, for example, glass and metal. The fired layer 43a can be made from a material that includes, for example, at least one metal of Cu, Ni, Ag, Pd, Au, etc. The fired layer 43a may include a single layer or a plurality of layers.

The fired layer 43a can be formed as follows, for example. First, an electrically conductive paste is applied over the metal layer 41a. The electrically conductive paste includes glass and metal. Next, the applied electrically conductive paste is fired. As a result, the fired layer 43a can be formed. This firing process, or baking, can be performed simultaneously with the firing of the multilayer body 2. Alternatively, the firing of the fired layer 43a can be performed after the firing of the multilayer body 2. The fired layer 43a will be described later in further detail.

### Glass Film

The glass film 42a primarily includes glass. The glass film 42a is provided around the metal layer 41a. As illustrated in FIG. 2, the glass film 42a is provided around the metal layer 41a, adjacent to the metal layer 41a and encircling the metal layer 41a. Specifically, the glass film 42a is in contact with the end portion 5 of the metal layer 41a. The glass film 42a extends from a portion of the first end surface E1 of the multilayer body 2 to a portion of the first main surface M1. Similarly, the glass film 42a extends from a portion of the first end surface E1 of the multilayer body 2 to a portion of the second main surface M2. Although not illustrated in FIG. 2, the glass film 42a also extends from a portion of the first end surface E1 of the multilayer body 2 to a portion of the first lateral surface S1 and a portion of the second lateral surface S2.

The glass film 42a is formed together with the fired layer 43 during the formation process of the fired layer 43a. During the formation process of the fired layer 43a, an electrically conductive paste is applied to the first end surface E1. The electrically conductive paste includes glass. During the firing process, the glass migrates to the portion where the dielectric layer 7 is exposed. The portion where the dielectric layer 7 is exposed is the portion of the multilayer body 2 not covered by the metal layer 41a. The glass migrates to a portion of the first end surface E1, a portion of the first main surface M1, a portion of the second main surface M2, a portion of the first lateral surface S1, and a portion of the second lateral surface S2. After firing, the glass that migrated to the exposed portion of the dielectric layer 7 forms the glass film 42a.

As described, during the firing process, the glass included in the electrically conductive paste migrates to the portion where the dielectric layer 7 is exposed. Therefore, the glass content in the glass film 42a is higher than that in the fired layer 43a.

### Ratio of Metal and Glass in Fired Layer

The glass content in the surface of the fired layer 43a is preferably low. This improves the adhesion of the plating film 44a to the surface of the fired layer 43a. This also improves the bond between the surface of the fired layer 43a and the plating film 44a.

Specifically, the area of the portion made of metal on the surface of the fired layer 43a facing the plating film 44a is, for example, preferably greater than about ten times the area of the portion made of glass. This sufficiently improves the adhesion of the plating film 44a to the fired layer 43a. This also sufficiently improves the bond between the fired layer 43a and the plating film 44a.

The glass film 42a does not need to be made solely from glass. The glass film 42a may also include, for example, other materials such as metals, in addition to glass. However, a higher proportion of glass in the glass film 42a is preferred. A higher proportion of glass improves the advantageous effect of preventing moisture from penetrating into the interior of the multilayer body 2, as will be discussed later.

As such, the glass film 42a is provided in contact with the end portion 5 of the metal layer 41a, adjacent to the metal layer 41a and encircling the metal layer 41a. In other words, the end portion 5 of the metal layer 41a is filled and sealed with the glass film 42a. This enables preventing moisture from entering the interface between the dielectric layer 7 and the internal electrodes 8 from the surroundings of the metal layer 41a.

From the perspective of reducing or preventing moisture penetration, the glass film 42a preferably seamlessly contacts the end portion 5 along the entire or substantially the entire circumference of the metal layer 41a, thus covering the entire or substantially the entire circumference of the metal layer 41a.

Whether the glass film 42a is provided on the surface of the multilayer body 2 can be determined by appropriately polishing the concerned area of the multilayer body 2 and performing elemental analysis with a field emission wavelength dispersive X-ray spectrometer.

### Plating Film

The plating film 44a is a metallic film formed by plating. The plating film 44a is provided to cover the fired layer 43a. The plating film 44a is made from a material that includes, for example, at least one metal of Cu, Ni, Ag, Pd, Au, etc. The plating film 44a may also be made from alloys, such as, for example, an alloy of Ag and Pd. The plating film 44a does not include glass.

The plating film 44a includes a bottom plating film and a top plating film. The top plating film is provided over the bottom plating film. The bottom plating film is made from a material that includes, for example, at least one metal of Cu, Ni, Ag, Pd, an alloy of Ag and Pd, Au, etc. The top plating film is made from, for example, Sn as the material. Using Sn as the material of the top plating film can improve the solder wettability to the first external electrode 4a. The thickness of the top plating film can be, for example, between about 1 μm and about 10 μm inclusive. Similarly, the thickness of the plating films 44a, 44b can be, for example, between about 1 μm and about 10 μm inclusive.

The description provided for the first external electrode 4a also applies to the second external electrode 4b. The first and second external electrodes 4a and 4b are the same or similar except for being provided on different surfaces. Therefore, the metal layer 41b, the glass film 42b, the fired layer 43b, and the plating film 44b of the second external electrode 4b are similar to those components described for the first external electrode 4a.

### Size of Multilayer Ceramic Capacitor

The total length of the multilayer ceramic capacitor 1 in the length direction L, including the multilayer body 2 and the external electrodes 4, can be, for example, between about 0.2 mm and about 2.0 mm inclusive. The total length of the multilayer ceramic capacitor 1 in the thickness direction T can be, for example, between about 0.1 mm and about 1.2 mm inclusive. The total length of the multilayer ceramic capacitor 1 in the width direction W can be, for example, between about 0.1 mm and about 1.2 mm inclusive.

### Details of External Electrodes

Based on FIG. 2, the external electrodes 4 will be described in detail. FIG. 2, as previously described, is a cross-sectional view along the line I-I in FIG. 1. Here, the cross-sectional view along the line I-I represents a cross-sectional view in the LT plane at the central position of the multilayer ceramic capacitor 1 in the width direction W. The central position in the width direction W is indicated in FIG. 3. The position of the line I in FIG. 3 represents the central position of the multilayer ceramic capacitor 1 in the width direction W. FIG. 3 is a cross-sectional view along the III-III in FIG. 1. FIG. 3 illustrates the WT cross-section of the multilayer ceramic capacitor 1. The LT cross-section at the central position of the multilayer ceramic capacitor 1 in the width direction W illustrated in FIG. 2 will be referred to as the ½ LT cross-section.

Below, the first external electrode 4a will be taken as an example to explain the external electrodes 4. The second external electrode 4b is the same or similar in configuration to the first external electrode 4a. Therefore, the following description is also applicable to the second external electrode 4b.

### Metal Layer and Glass Film

As illustrated in FIG. 2, the metal layer 41a is provided across the entire or substantially the entire area of the first end surface E1. However, instead of the metal layer 41a, the glass film 42a may be provided near the areas of the first main surface M1 and the second main surface M2 on the first end surface E1. The glass film 42a is in contact with the end portion 5 of the metal layer 41a. Although not illustrated in FIG. 2, the glass film 42a is also provided near the areas of the first lateral surface S1 and the second lateral surface S2 on the first end surface E1. This glass film 42a is also in contact with the end portion 5 of the metal layer 41a. Thus, the glass film 42a is provided to cover the surroundings of the metal layer 41a.

More specifically, the glass film 42a on the first end surface E1 extends from the end portion 5 of the metal layer 41a to portion of the first main surface M1 and the second main surface M2. Although not illustrated in FIG. 2, the glass film 42a also extends from the end portion 5 of the metal layer 41a to portion of the first lateral surface S1 and the second lateral surface S2. In other words, the glass film 42a is provided to cover the edge portions of the multilayer body 2, between the first end surface and the two main and two lateral surfaces.

The fired layer 43a is not provided over the entire area of the metal layer 41a. As illustrated in FIG. 2, the outer edge of the fired layer 43a is provided inside the outer edge of the metal layer 41a, near the end portion of the first end surface E1. In other words, the fired layer 43a does not continuously extend from the first end surface E1 to a portion of the first main surface M1 and the second main surface M2. The fired layer 43a is discontinuous once near the edge portion of the first end surface E1 and the first main surface M1, and near the edge portion of the first end surface E1 and the second main surface M2. The edge portion, as described earlier, is where two surfaces of the multilayer body 2 intersect. As such, since the fired layer 43a is discontinuous once near the edge portions, the end portion 5 of the metal layer 41a is not covered by the fired layer 43a. In other words, the end portion 5 of the metal layer 41a is exposed at the fired layer 43a.

Although not illustrated in FIG. 2, the fired layer 43a is also provided on a portion of the first lateral surface S1 and the second lateral surface S2. However, similar to the first main surface M1 and the second main surface M2, the fired layer 43a does not continuously extend from the first end surface E1 to the first lateral surface S1 and the second lateral surface S2. The fired layer 43a is discontinuous once near the edge portion of the first end surface E1 and the first lateral surface S1, and near the edge portion of the first end surface E1 and the second lateral surface S2. As a result, the end portion 5 of the metal layer 41a is not covered by the fired layer 43a. In other words, the end portion 5 of the metal layer 41a is exposed at the fired layer 43a.

As described, the fired layer 43a does not cover the entire circumference of the metal layer 41a. For example, the entire circumference of the metal layer 41a is exposed at the fired layer 43a. This will be further described later based on FIG. 4.

### Plating Film

The plating film 44a is provided to cover the entirety or substantially the entirety of the fired layer 43a. That is, the plating film 44a is provided beyond the range of the fired layer 43a, covering the first end surface E1 and a portion of the two main surfaces. Although not illustrated in FIG. 2, the plating film 44a is also provided on a portion of the two lateral surfaces, similar to the two main surfaces.

Below, the arrangement of the metal layer 41a and the fired layer 43a will be described based on the WT cross-section of the multilayer ceramic capacitor 1.

### WT Cross-Section

FIGS. 3 and 4 both illustrate the WT cross-section of the multilayer ceramic capacitor 1. However, the location of the cross-section differs between FIGS. 3 and 4.

FIG. 3, as previously described, is a cross-sectional view along the line III-III in FIG. 1. FIG. 3 illustrates the WT cross-section along the line L1 in FIG. 2. As illustrated in FIG. 3, the glass film 42a is provided on the outside of the multilayer body 2, encircling the entire or substantially the entire circumference of the multilayer body 2. The fired layer 43a is provided on the outside of the glass film 42a, encircling the entire or substantially the entire circumference of the glass film 42a. Furthermore, the plating film 44a is provided on the outside of the fired layer 43a, encircling the entire or substantially the entire circumference of the fired layer 43a.

FIG. 4 is a cross-sectional view along the line IV-IV in FIG. 1. FIG. 4 illustrates the WT cross-section along the line L2 in FIG. 2. As illustrated in FIG. 4, the plating film 44a is provided around the metal layer 41a. The fired layer 43a is not provided around the metal layer 41a. Therefore, the entire or substantially the entire circumference of the metal layer 41a is exposed at the fired layer 43a.

### Thickness of Fired Layer

Based on FIG. 2, the thickness d2 of the fired layer 43a is described. FIG. 2 illustrates the LT cross-section of the multilayer ceramic capacitor 1. The thickness of the fired layer 43a is indicated as d2 in FIG. 2. In the present example embodiment, the thickness of the fired layer 43a is relatively thin. Specifically, in the present example embodiment of the multilayer ceramic capacitor 1, the thickness d2 of the fired layer 43a is, for example, between about 0.1 μm and about 1.0 μm inclusive. As described earlier, the thickness d1 of the metal layer 41a is, for example, between about 0.1 μm and about 15.0 μm inclusive. Therefore, in the present example embodiment of the ceramic capacitor 1, the thickness d2 of the fired layer 43a is significantly thin, as compared to the thickness of the metal layer 41a.

### Voids in Fired Layer

Based on FIG. 2, the voids 6 in the fired layer 43a are described. In the present example embodiment of the multilayer ceramic capacitor 1, the voids 6 are provided in the fired layer 43a. The voids 6 are portions within the fired layer 43a that are not filled with glass or metal material. The glass or metal material referred to here is included in the electrically conductive paste used during the formation of the fired layer 43a.

### Position of Voids

As illustrated in FIG. 2, the voids 6 are provided throughout the fired layer 43a in the thickness direction. However, the voids 6 are more preferably provided at least near the metal layer 41a.

### Filling of Plating Material

The plating film 44a is provided on the outside of the fired layer 43a. Therefore, at least a portion of the voids 6 includes plating material. The plating material enters the voids 6 during the formation of the plating film 44a.

### ½ LT Cross-Section and Lateral End LT Cross-Section

The LT cross-section illustrated in FIG. 2 is, as described earlier, the LT cross-section at the central position of the multilayer ceramic capacitor 1 in the width direction W. That is, the LT cross-section illustrated in FIG. 2 is the ½ LT cross-section. In the present example embodiment of the multilayer ceramic capacitor 1, the LT cross-section near the lateral surfaces in the width direction W is the same as or similar to the LT cross-section at the central position in the width direction W, that is, the ½ LT cross-section. The LT cross-section near the lateral surfaces in the width direction W refers to, for example, the cross-section along the line II-II in FIG. 1. This cross-section corresponds to, for example, the LT cross-section at the position of the end surface on the side of the first lateral surface S1 of the internal electrode 8. This corresponds to the LT cross-section along the line II in FIG. 3. This cross-section is referred to as the lateral end LT cross-section. In the present example embodiment, there is no significant difference between the ½ LT cross-section and the lateral end LT cross-section. In other words, there is no significant difference between the LT cross-section along the line I in FIG. 3 and the LT cross-section along the line II in FIG. 3.

In the present example embodiment of the multilayer ceramic capacitor 1, although not illustrated, there is also no significant difference in the arrangement of the external electrodes 4 or other aspects across LW cross-sections at different positions in the thickness direction T.

This indicates that the thickness of the external electrodes 4, especially of the fired layer 43a, does not vary significantly within the plane.

Therefore, in the present example embodiment of the multilayer ceramic capacitor 1, as illustrated in the WT cross-section in FIG. 4, the entire or substantially the entire circumference of the metal layer 41a can be easily exposed at the fired layer 43a. If the thickness of the fired layer 43a varies significantly within the plane, a portion of the fired layer 43a may extend beyond the outer edge of the metal layer 41a. As a result, it is difficult to allow the entire or substantially the entire circumference of the metal layer 41a to be exposed at the fired layer 43a.

### Advantageous Effects

The multilayer ceramic capacitor 1 of the present example embodiment is capable of reducing or preventing the occurrence of cracks in the external electrodes 4. The multilayer ceramic capacitor 1 of the present example embodiment has improved moisture resistance reliability.

### Conventional Multilayer Ceramic Capacitors

In conventional multilayer ceramic capacitors in which a metal layer is provided on the external electrodes, cracks may occur in the metal layer. One cause of cracks in the metal layer is stress applied from other components. The fired layer is one such component. The fired layer is provided in contact with the metal layer. The fired layer may experience stress due to changes in environmental temperature or humidity. This stress is applied to the metal layer. This stress causes cracks in the metal layer. When cracks occur in the metal layer, the moisture penetration prevention function of the metal layer is compromised. Replacing this moisture penetration prevention function with other layers such as the fired layer is not easy. This is because other layers are less dense than the metal layer. Therefore, reducing or preventing the occurrence of cracks is critical.

### Thickness of Metal Layer

In the present example embodiment of the multilayer ceramic capacitor 1, the thickness of the metal layer 41a is, for example, between to 0.1 μm and to 15.0 μm inclusive. The thickness of the fired layer 43a is, for example, between to 0.1 μm and to 1.0 μm inclusive. In the present example embodiment of the multilayer ceramic capacitor 1, the thickness of the fired layer 43a is relatively thin. The thinness of the fired layer 43a enables the reduction of stress within the fired layer 43a. This enables a reduction or prevention of the occurrence of cracks in the metal layer 41a.

By keeping the thickness of the fired layer 43a to about 1.0 μm or less, the continuity of the fired layer 43a can be reduced. Reduced continuity weakens the in-plane bonding of the fired layer 43a. The weakened bonding reduces the stress within the fired layer 43a. As a result, the occurrence of cracks in the metal layer 41a can be reduced or prevented.

Keeping the thickness of the fired layer 43a to about 1.0 μm or less also allows for the thin-film formation of the external electrodes 4. As a result, the external dimensions of the multilayer ceramic capacitor 1 can be reduced.

In the present example embodiment of the multilayer ceramic capacitor 1, the area of the metal portion on the surface of the fired layer 43a, facing the plating film 44a, is greater than about ten times the area of the glass portion. This ensures the plating adhesion of the plating film 44a to the fired layer 43a. The term “plating adhesion” refers to the ease with which plating adheres, including, for example, the adhesiveness of the plating film 44a to the fired layer 43a and the cohesion between the fired layer 43a and the plating film 44a.

### Voids in Fired Layer

In the present example embodiment of the multilayer ceramic capacitor 1, the fired layer 43a includes the voids 6. Since the fired layer 43a includes voids 6, stress in the fired layer 43a can be reduced. As a result, the occurrence of cracks in the metal layer 41a can be reduced or prevented.

### Exposure of Metal Layer

In the present example embodiment of the multilayer ceramic capacitor 1, at least a portion of the metal layer 41a is exposed at the fired layer 43a. Specifically, when the metal layer 41a is viewed from the length direction L, the fired layer 43a is not provided around the metal layer 41a. As a result, the vicinity of the outer edge of the metal layer 41a is exposed at the fired layer 43a over the entire or substantially the entire circumference of the outer edge.

In the present example embodiment of the multilayer ceramic capacitor 1, at least a portion of the metal layer 41a is exposed at the fired layer 43a, enabling further reduction or prevention of the occurrence of cracks in the metal layer 41a.

The metal layer 41a is exposed at the fired layer 43a, which weakens the stress applied to the exposed portions of the metal layer 41a from the fired layer 43a. Therefore, the occurrence of cracks in the metal layer 41a can be reduced or prevented.

The exposed portions of the metal layer 41a are the portions where the fired layer 43a is interrupted. The presence of interrupted portions in the fired layer 43a weakens the in-plane bonding of the fired layer 43a. This reduces the stress in the fired layer 43a. As a result, the occurrence of cracks in the metal layer 41a can be reduced or prevented.

### Method of Manufacturing Multilayer Ceramic Capacitor

An overview of an example of a method of manufacturing the multilayer ceramic capacitor 1 is described.
(1) Prepare ceramic green sheets for the dielectric layer 7 and electrically conductive paste for the internal electrodes 8.
(2) Form internal electrode patterns on the ceramic green sheets. The patterns can be formed by, for example printing the electrically conductive paste in a predetermined pattern on the ceramic green sheets. The printing can be performed by methods such as, for example, screen printing or gravure printing.
(3) Stack a plurality of outer dielectric layer ceramic green sheets without internal electrode patterns formed thereon. Sequentially stack ceramic green sheets with internal electrode patterns printed thereon on top. Then, stack a plurality of outer dielectric layer ceramic green sheets on top. As a result, a multilayer sheet is prepared.
(4) Press the multilayer sheet in the thickness direction using a hydrostatic press, for example. As a result, a multilayer block is prepared.
(5) Cut the multilayer block to a predetermined size. As a result, multilayer chips are produced.
(6) Round the corner portions and edge portions of the multilayer chips through processes such as. For example, barrel polishing.
(7) Fire the multilayer chips. As a result, a fired multilayer body is obtained.
(8) Form metal layers on the end surfaces of the fired multilayer body. Specifically, form metal layers on the end surfaces to cover the internal electrodes extending to the end surfaces of the multilayer body. The metal layers can be formed by plating, for example. Plating can be performed using, for example, electrolytic plating or electroless plating. For the plating method, barrel plating can be used, for example.
(9) Apply an electrically conductive paste for the fired layer on the metal layers.
(10) Dry the electrically conductive paste. Perform firing after drying. As a result, the fired layers 43a, 43b are formed. Glass included in the electrically conductive paste for the fired layers 43a, 43b migrates to the surface of the dielectric layer 7. The moved glass migrates to the surface of the dielectric layer 7. The migrated glass becomes the glass films 42a, 42b.
(11) Form plating films on the fired layers 43a, 43b. Specifically, first perform Ni plating to cover the fired layers 43a, 43b. As a result, the bottom plating film is formed. Then, perform Sn plating on top. As a result, the top plating film is formed.

### Characteristics of Manufacturing Method

In addition to the example method of manufacturing the multilayer ceramic capacitor previously described, the example method of manufacturing the multilayer ceramic capacitor 1 of the present example embodiment includes the following characteristics.

In the present example embodiment of the multilayer ceramic capacitor 1, the thickness of the fired layer 43a is relatively thin. Therefore, when applying the electrically conductive paste for the fired layer 43a to the metal layer 41a, the amount of paste applied is precisely controlled. This allows for the formation of the fired layer 43a with a thickness of to 1.0 μm or less.

In the present example embodiment of the multilayer ceramic capacitor 1, the fired layer 43a includes the voids 6. Both of the firing temperature and firing time are optimized to form the voids 6. Specifically, firing is conducted at a temperature between, for example, about 600° C. and about 750° C. inclusive for duration between 5 and 15 minutes inclusive. The temperature in a range between, for example, about 650° C. and about 700°° C. inclusive is more preferable. The duration less than about 15 minutes, for example, is more preferable. The firing can be performed under an inert gas atmosphere, such as nitrogen gas, for example. By firing under such conditions, the voids 6 can be formed within the fired layer 43a.

However, the firing process does not form the glass film 42a. The glass film 42a is formed as glass included in the electrically conductive paste for forming the fired layer 43a moves to the portions where the dielectric layer 7 is exposed. In the firing process, the glass does not migrate sufficiently, and thus the glass film 42a is not formed. Therefore, in addition to the firing, firing in an atmospheric environment is also conducted. This firing can be conducted, for example, at about 700° C. for about 5 minutes in an atmospheric environment. This firing in an atmospheric environment allows for forming the fired layer 43a. During firing in an atmospheric environment, metal particles such as, for example, Cu included in the fired layer 43a oxidize. The glass spreads over the surface of the oxidized metal particles. This promotes the movement of glass. The glass further spreads over the surface of the dielectric layer 7, which is formed of an oxide such as, for example, BaTiO₃, resulting in the formation of the glass film 42a.

Furthermore, in the present example embodiment of the multilayer ceramic capacitor 1, the thickness of the fired layer 43a is, for example, about 1.0 μm or less. As a result, the continuity of the fired layer 43a can be easily reduced. Reduced continuity reduces the necking of metal particles such as Cu within the fired layer 43a, which in turn limits the action of pushing out the glass onto the surface of the dielectric layer 7. That is, the formation of the glass film 42a becomes more challenging. Consequently, additional firing in an atmospheric environment to promote the migration of glass becomes more effective.

### Method of Measuring Length

Examples of methods of measuring the lengths of various portions of the multilayer ceramic capacitor 1 may involve using a scanning electron microscope to observe the cross-section of the multilayer body exposed by polishing. The values can be the average of a plurality of measurement values corresponding to the portion to be measured.

### Moisture Resistance Reliability Test

A moisture resistance reliability test was conducted as a durability test. The samples and test conditions are as follows:

### Sample

Length in the length direction L: about 0.6 mm
Length in the width direction W: about 0.3 mm
Length in the thickness direction T: about 0.3 mm
Capacitance: about 2.2 μF
Thickness of the inner dielectric layer 7b: about 0.65 μm
Thickness of the internal electrodes 8: about 0.43 μm
Number of the internal electrodes 8: 280 layers
Thickness of the metal layers 41a, 141b: about 5 μm

### Moisture Resistance Reliability Test

Temperature, Humidity: about 85° C. and about 85% RH
Voltage: about 6.3 V
Voltage application time: about 120 hours
Judgment criteria: Samples that showed a decrease of two orders of magnitude or more in the logarithmic value of insulation resistance (log IR) immediately after the start of the moisture resistance reliability test were judged to include IR degradation.

A moisture resistance reliability test was conducted using 72 samples of the present example embodiment of the present invention and 72 conventional samples. The samples of the present example embodiment are the fired layers 43a with a thickness of about 0.5 μm. On the other hand, the conventional samples are the fired layers 43a with a thickness of about 3.0 μm. The results of the moisture resistance reliability test were as follows. No IR degradation was observed in all the 72 samples of the example embodiment. On the other hand, IR degradation was observed in 3 samples of the 72 conventional samples.

In the conventional samples, it is presumed that cracks occurred in the metal layer during the moisture resistance reliability test, resulting in IR degradation. Conversely, in the samples of the present example embodiment, it is presumed that no cracks occurred in the metal layer during the moisture resistance reliability test, leading to no IR degradation occurrence.

From the test results, it can be understood that the multilayer ceramic capacitor of the present example embodiment has improved moisture resistance reliability and is capable of reducing or preventing the occurrence of cracks in the external electrodes.

The description so far has been primarily based on the first external electrode 4a. As described previously, the description for the first external electrode 4a also applies to the second external electrode 4b. The first and second external electrodes 4a and 4b are similar except for being provided on different surfaces.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including a plurality of dielectric layers and a plurality of internal electrodes alternately stacked; and
a pair of external electrodes on surfaces of the multilayer body and electrically connected to the internal electrodes extending to the surfaces of the multilayer body, respectively; wherein
the multilayer body includes:
a first main surface and a second main surface on opposite sides in a thickness direction that is a lamination direction of the dielectric layers and the internal electrodes;
a first end surface and a second end surface on opposite sides in a length direction in which the external electrodes face each other, the external electrodes being provided on the first end surface and the second end surface; and
a first lateral surface and a second lateral surface on opposite sides in a width direction orthogonal or substantially orthogonal to both of the thickness direction and the length direction;
the external electrodes include:
a metal layer on the first end surface and the second end surface, and covering the internal electrodes extending to the first end surface and second end surface, respectively;
a glass film on the first end surface and second end surface, adjacent to the metal layer and extending around the metal layer;
a fired layer including glass and metal, and covering the metal layer; and
a plating film covering the fired layer;
a thickness of the metal layer is between about 0.1 μm and about 15.0 μm inclusive; and
a thickness of the fired layer is between about 0.1 μm and about 1.0 μm inclusive.

2. The multilayer ceramic capacitor according to claim 1, wherein
the fired layer includes voids; and
at least a portion of the voids includes plating material.

3. The multilayer ceramic capacitor according to claim 1, wherein an area of a metal portion is more than about ten times greater than an area of a glass portion, on a surface of the fired layer facing the plating film.

4. The multilayer ceramic capacitor according to claim 1, wherein a glass film in contact with an end portion of the metal layer extends around the metal layer.

5. The multilayer ceramic capacitor according to claim 1, wherein the multilayer body has a rectangular or substantially rectangular shape.

6. The multilayer ceramic capacitor according to claim 1, wherein the multilayer body has dimension in the length direction between about 200 μm and about 2000 μm inclusive, a dimension in the thickness direction between about 100 μm and about 1000 μm inclusive, and a dimension in the width direction between about 100 μm and about 1000 μm inclusive.

7. The multilayer ceramic capacitor according to claim 1, wherein a number of the dielectric layers is between 10 and 1000 inclusive.

8. The multilayer ceramic capacitor according to claim 1, wherein a thickness of each of the plurality of dielectric layers is about 0.3 μm and about 5.0 μm inclusive.

9. The multilayer ceramic capacitor according to claim 1, wherein each of the plurality of dielectric layers includes at least one of BaTiO₃, CaTiO₃, SrTiO₃, or CaZrO₃ as a main component.

10. The multilayer ceramic capacitor according to claim 9, wherein each of the plurality of dielectric layers includes at least one of a Mn compound, a Fe compound, a Cr compound, a Co compound, or a Ni compound.

11. The multilayer ceramic capacitor according to claim 1, wherein a number of the plurality of internal electrodes is between 10 and 100 inclusive.

12. The multilayer ceramic capacitor according to claim 1, wherein a thickness of each of the plurality of internal electrodes is between about 0.3 μm and about 5.0 μm inclusive.

13. The multilayer ceramic capacitor according to claim 1, wherein each of the plurality of internal electrodes includes at least one of Ni, Cu, Ag, Pd, Au, an alloy of Ni and Cu, or an alloy of Ag and Pd.

14. The multilayer ceramic capacitor according to claim 1, wherein the metal layer includes at least one of Cu, Ni, Ag, Pd, or Au.

15. The multilayer ceramic capacitor according to claim 1, wherein a thickness of the metal layer is between about 0.1 μm and about 15.0 μm inclusive.

16. The multilayer ceramic capacitor according to claim 1, wherein the fired layer includes at least one of Cu, Ni, Ag, Pd, or Au.

17. The multilayer ceramic capacitor according to claim 1, wherein the plating film includes at least one of Cu, Ni, Ag, Pd, or Au.

18. The multilayer ceramic capacitor according to claim 1, wherein the plating film does not include glass.
